(19) United States
(12) Patent Application Publication
(10) Pub. No.: US 2025/0298817 A1
(43) Pub. Date: Sep. 25, 2025

(54) PROMPT ENHANCEMENT

(71) Applicant: Zoom Video Communications, Inc., San Jose, CA (US)

(72) Inventors: Bilung Lee, San Jose, CA (US); Renjie Tao, Santa Clara, CA (US); Liwei Wu, Hangzhou (CN)

(73) Assignee: Zoom Video Communications, Inc., San Jose, CA (US)

(21) Appl. No.: 18/613,959

(22) Filed: Mar. 22, 2024

(51) Int. Cl. G06F 16/332; G06F 16/34

(52) U.S. Cl. CPC G06F 16/3329; G06F 16/345

(57) ABSTRACT

Example methods and systems for prompt enhancement are provided. A communication platform accesses an initial meta prompt. The initial meta prompt is a prompt for a generative model to enhance a task prompt. The communication platform generates a first set of variant meta prompts using a first generative model based on the initial meta prompt. The communication platform generates a first set of enhanced baseline task prompts corresponding to a set of baseline task prompts using a second generative model based on the first set of variant meta prompts. The communication platform evaluates the first set of variant meta prompts to obtain a first set of evaluation data. The communication platform selects a first variant meta prompt as a first optimized meta prompt based on the first set of evaluation data. The communication platform provides the first optimized meta prompt to a third generative model for task prompt enhancement.

### FIELD

The present application generally relates to artificial intelligence or machine learning, and more specifically relates to prompt enhancement.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing and chat functionality to various client devices;

FIG. 2 shows an example system in which a chat and video conference provider provides videoconferencing and chat functionality to various client device;

FIG. 3 shows an example system for using LLMs for meta prompt optimization and task prompt enhancement;

FIG. 4 shows an example system that is configured to provide an optimized meta prompt for task prompt enhancement;

FIG. 5 shows an example diagram of providing an optimized meta prompt for task prompt enhancement;

FIG. 6 shows an example process for providing an optimized meta prompt for task prompt enhancement;

FIG. 7 shows an example process for evaluating variant meta prompt;

FIG. 8 shows an example process for performing a generative task based on a task prompt; and

FIG. 9 shows an example computing device suitable for use in example systems or methods for prompt enhancement, according to certain examples.

### DETAILED DESCRIPTION

Examples are described herein in the context of prompt enhancement. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

A prompt can provide instructions to an artificial intelligence (AI) or machine learning (ML) model for a certain task. The AI or ML model, for example a large language model (LLM), can generate an output based on an input and a prompt; however, the quality of the prompt can affect the quality of the output. Not every user is trained to write sophisticated prompts for AI or ML models for performing various tasks and so they may not be able to take full advantage of the AI or ML model's capabilities.

To obtain high-quality outputs from an AI/ML model for generative tasks, it is desirable to enhance a task prompt before it is provided to the AI/ML model. For example, a communication platform may provide a meta prompt to facilitate the enhancement of the task prompts. The meta prompt can be considered as a prompt about a task prompt. In other words, a meta prompt can instruct an AI/ML model to generate an enhanced prompt based on an initial task prompt as input.

A meta prompt rephrasing module on the communication platform can generate multiple variant meta prompts based on an initial meta prompt using an LLM trained for rephrasing. The initial meta prompt is a pre-defined meta prompt that can be applied to a task prompt to enhance the task prompt. However, the meta prompt itself may be improved by generating variant meta prompts and testing their effectiveness at improving a task prompt. Certain parameters of the trained LLM can be adjusted, for example the temperature parameter can be adjusted higher to diversify the variant meta prompts generated from the initial meta prompt. The meta prompt rephrasing module can also use evaluation data associated with previously generated variant meta prompts as feedback to refine or fine-tune the trained LLM when generating variant meta prompts.

The communication platform may also provide a set of baseline task prompts, a set of baseline inputs, and a set of baseline outputs, which can be stored in a data store and used to evaluate the multiple variant meta prompts. The set of baseline outputs are generated based on the set of baseline inputs and the set of baseline task prompts using a generative model. A task prompt enhancing module on the communication platform can generate an enhanced baseline task prompt using a trained LLM, with a baseline task prompt as input and a variant meta prompt as a prompt. The multiple variant meta prompts can be used as prompts for the task prompt enhancing module to generate a set of enhanced baseline task prompts for a set of baseline task prompts.

A prompt evaluation module on the communication platform can evaluate the multiple variant meta prompts. For example, the prompt evaluation module applies an enhanced baseline task prompt to a baseline input to obtain an enhanced baseline output using a trained LLM. The prompt evaluation module can evaluate the enhanced baseline output corresponding to the enhanced baseline task prompt and the baseline output corresponding to the original baseline task prompt, to determine whether the enhanced output is better than the baseline output and provide evaluation data for the enhanced baseline output corresponding to the enhanced baseline task prompt. The evaluation data can also represent the quality of the corresponding enhanced baseline task prompt, and in turn the quality of a corresponding variant meta prompt. This way, the prompt evaluation module can evaluate the multiple variant meta prompts. The evaluation data can include evaluation scores and reasoning data corresponding to the multiple variant meta prompts. The variant meta prompt with the highest evaluation score can be provided as an optimized meta prompt to a trained LLM for task prompt enhancement. When a user provides a task prompt to the trained LLM for task prompt enhancement, unseen by the task prompt enhancing module, the trained LLM can generate an enhanced task prompt. The enhanced task prompt can then be provided to an LLM to generate an output based on an input and the enhanced task prompt.

Meanwhile, the prompt evaluation module can generate an evaluation summary based on the evaluation data for all the variant meta prompts. The evaluation summary can be provided to the meta prompt rephrasing module as feedback input to refine the trained LLM for rephrasing.

Thus, with this example prompt enhancement system and method, a task prompt written by a user can be enhanced as an enhanced task prompt that is more instructive and of better quality for an LLM to follow. An LLM prompted by the enhanced task prompt can generate an output with more details and better quality based on a user input.

This illustrative example is given to introduce the reader to the general subject matter discussed herein and the disclosure is not limited to this example. The following sections describe various additional non-limiting examples and examples of prompt enhancement.

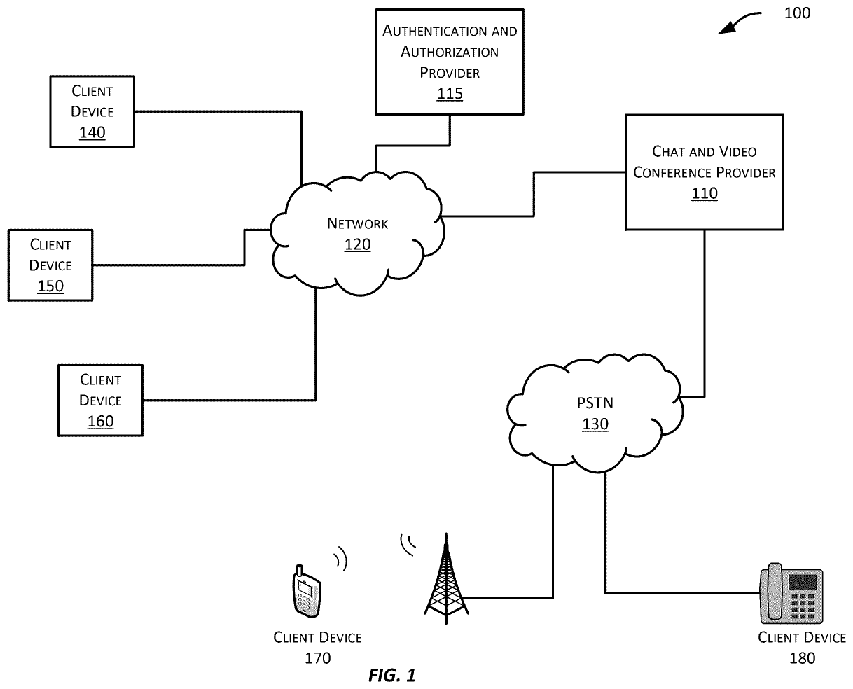

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

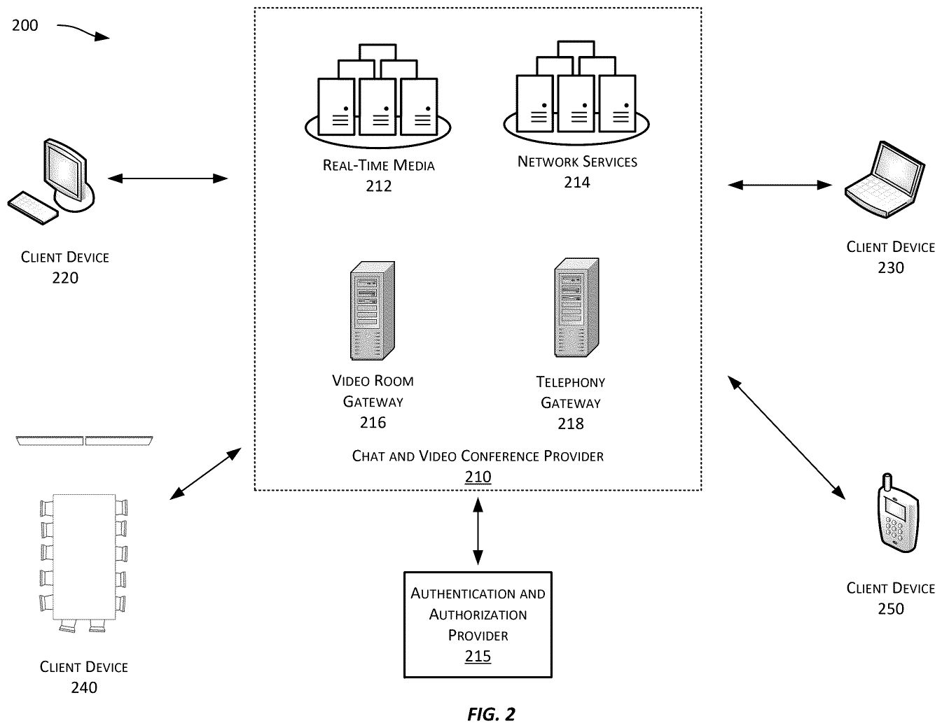

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O) as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

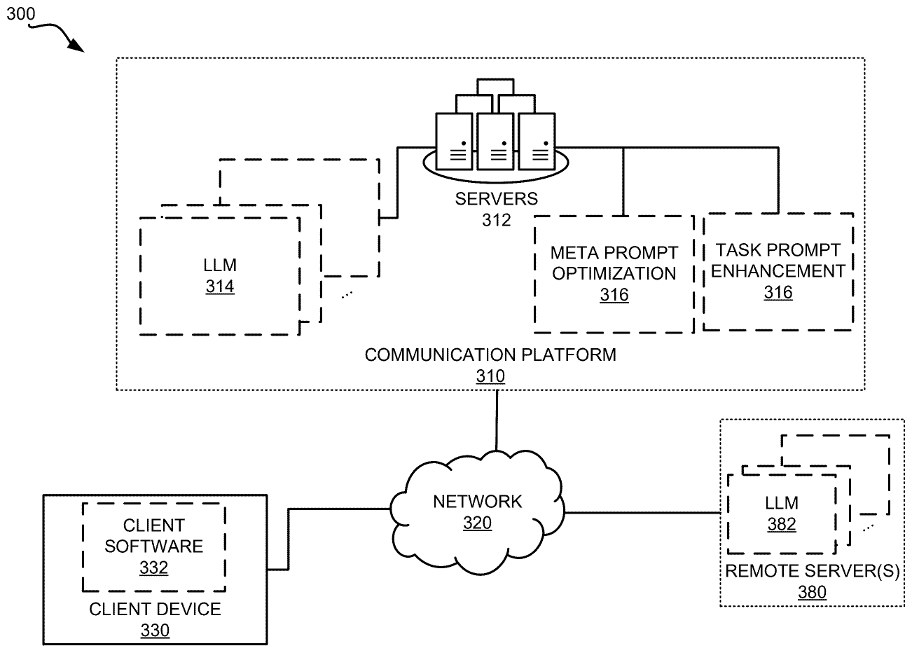

Referring now to FIG. 3, FIG. 3 shows an example system 300 for using LLMs for meta prompt optimization and task prompt enhancement. In this example, the system 300 includes a client device 330, a communication platform 310, and one or more remote servers 380 that host one or more LLMs 382 in network communication with network 320. In this example, the communication platform 310 provides chat and virtual conferencing capabilities, such as discussed above with respect to FIGS. 1-2, but also provides one or more servers 312 that provide one or more LLMs 314 that may be used to service requests received from users via their respective client devices, such as client device 330. In addition, the communication platform 310 provides meta prompt optimization functionality 316 to provide an optimized meta prompt for task prompt enhancement and task prompt enhancement functionality 318 to enhance task prompts.

The one or more LLMs 314 may include a model that has been trained on a large corpus of data, such as information available from licensed, commercially usable, non-public datasets. For LLMs, the training data may be written materials, such as webpages, documents, emails, or blogs that may be relevant to generating written works.

Client devices may execute client software 332 to join and participate in virtual conferences hosted by the communication platform 310. During a virtual conference, the participants can exchange audio and video streams, as discussed above with respect to FIGS. 1-2, to interact with each other, discuss any topics of interest, and share content. Similarly, the participants can continue any discussions outside of a virtual conference, such as by using chat functionality provided by the communication platform 310. They may also email each other using email services provided by the communication platform 310 or another third party.

In some examples, a user on the communication platform 310 wants to obtain some information based on certain communication data using a generative model. For example, a user wants to use a trained ML model, such as an LLM, to perform a generative task, for example, to generate a summary of the meeting transcript. Thus, a user needs to provide a task prompt to the trained ML model as instructions. However, user provided task prompts may not be written with clear structure and specific information used by LLMs, thus the output may not be as good as when a well written task prompt is provided.

To help with this process, the communication platform 310 can receive the user's task prompt and attempt to enhance it by using an LLM to generate an enhanced version of the user's task prompt. The communication platform 310 can do this by generating multiple meta prompts from the initial meta prompt and evaluating the different meta prompts. The communication platform 310 can then select the best meta prompt to provide to the LLM as a prompt for enhancing the user's task prompt. The enhanced task prompt can then be provided to an LLM to cause it to perform the user's requested generative task.

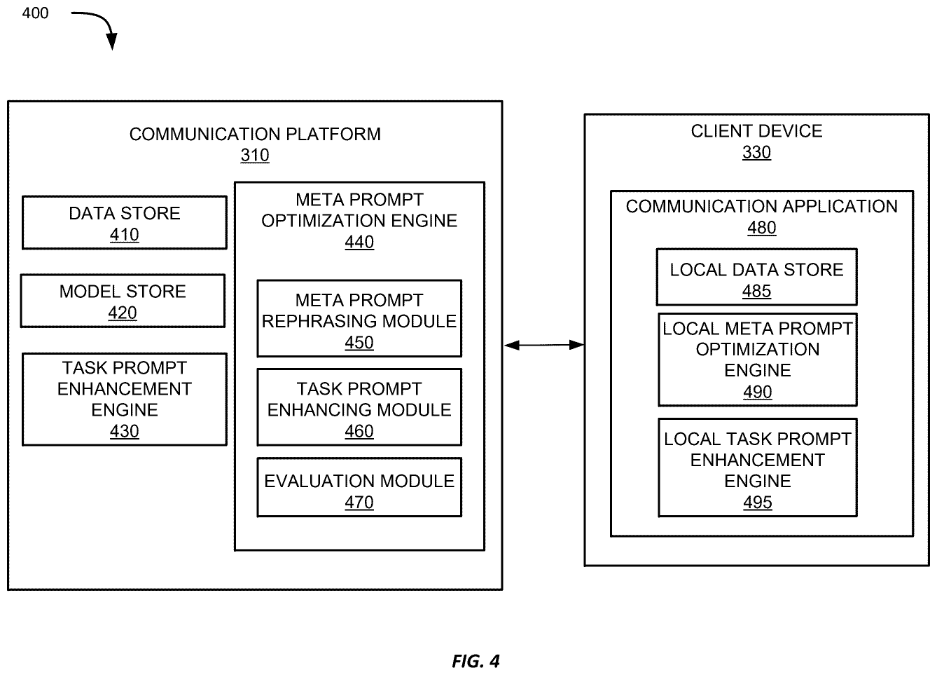

Referring now to FIG. 4, FIG. 4 shows an example system 400 that is configured to provide an optimized meta prompt for task prompt enhancement. The communication platform 310 is in network communication with a client device 330 installed with a communication application 480 provided by the communication platform 310. The communication platform 310 includes a data store 410, a model store 420, a task prompt enhancement engine 430, and a meta prompt optimization engine 440. The data store 410 stores historical communication data associated with different client devices 330, among other types of data. The historical communication data can include video conference recordings, video conference transcripts, chat messages, emails, and other types of communication data. The historical communication data can be used as inputs to LLMs for generating outputs for certain generative tasks. The outputs from the LLMs based on the inputs can also be stored in the data store 410. The data store 410 also stores a baseline dataset for meta prompt optimization. The baseline dataset can include a set of baseline task prompts, a set of baseline inputs, and a set of baseline outputs. A baseline input can be any suitable data that are pre-selected inputs to a generative model for evaluating variant meta prompts. The set of baseline inputs are generally provided by an operator of the communication platform 310, and not by a user who provides a task prompt for enhancement. Examples of baseline inputs can include certain communication data, such as meeting transcripts, chat messages, emails. A baseline output can be output data generated by a generative model using a baseline input as input data and a baseline task prompt as a prompt. Examples of baseline task prompts can include instructions for summary generation, paraphrase generation, question-answer generation, evaluation generation. Correspondingly, examples of baseline output can include summaries, paraphrases, question-answer pairs, and evaluation results.

The model store 420 includes different AI/ML models, including LLMs for various generative tasks. In some examples, the model store 420 stores the LLMs on the communication platform 310. In some examples, the model store 420 includes APIs for accessing various LLMs from different parts of the communication platform or from a third-party platform. Examples of target LLMs include GPT models of different versions, autoregressive LLMs (e.g., Large Language Model Meta A (LLaMA)), transformer-based autoregressive LLMs (e.g., BigScience Large Open-science Open-access Multilingual Language Models (BLOOMs)), Zephyr, MISTRAL, causal decoder-only models (e.g., Falcon), or MosaicML Pretrained Transformer (MPT) models.

The task prompt enhancement engine 430 is configured to enhance a text prompt for a user. The task prompt enhancement engine 430 can implement or use a trained LLM from a model store 420 on the communication platform 310 or from a remote server 380. The trained LLM can generate an enhanced task prompt based on a task prompt provided by a user as input and a prompt instructing the trained LLM to enhance the task prompt. The prompt instructing the trained LLM to generate an enhanced task prompt can be considered as a meta prompt. The meta prompt can be optimized to instruct the trained LLM to generate an enhanced task prompt, which in turn can instruct another LLM to generate outputs with desired information, structure, or other suitable features. An example meta prompt can be “You are a senior prompt engineer. Please optimize user provided task prompts so that an LLM can better follow it.” An example task prompt can be “Based on the provided meeting transcript, please generate a summary.” An example enhanced task prompt can be “Based on the provided transcript, please generate a summary of the meeting. The summary should include information about participants of the meeting, key topics discussed in the meeting, different opinions expressed during the meeting, and action items identified from the meeting. Please ensure the summary is less than 500 words and well-structured.” The task prompt enhancing engine 430 can be a separate engine on the communication platform 310. Alternatively, it can be a module integrated into other generative functionalities of the communication platform 310.

The meta prompt optimization engine 440 is configured to provide an optimized meta prompt for the task prompt enhancement engine 430. The meta prompt optimization engine 440 can include a meta prompt rephrasing module 450, a task prompt enhancing module 460, and an evaluation module 470. The meta prompt rephrasing module 450 is configured to generate multiple variant meta prompts for an initial meta prompt. The meta prompt rephrasing module 450 can implement or use a trained LLM from a model store 420 on the communication platform 310 or from a remote server 380. An initial meta prompt can be the input of the trained LLM. The initial meta prompt can be predefined, for example by an operator of the communication platform 310, as a default prompt for enhancing user provided task prompts. The trained LLM can rephrase or paraphrase an input, for example the initial meta prompt, based on an instruction (which is a prompt to the trained LLM). For example, the instruction for the trained LLM is to rephrase the initial meta prompt to generate five variants. The number of the variants can be adjusted by an operator of the communication platform 310. Certain parameters in the trained LLM for meta prompt rephrasing can be adjusted to diversify the variants. For example, a temperature parameter of the trained LLM can be set in a range between 0 and 1. The higher the temperature parameter is, the less deterministic the generated result can become, thus the variant meta prompts generated can be more diversified and different from the initial meta prompt. In some examples, the trained LLM for meta prompt rephrasing uses evaluation data associated with previously generated variant meta prompts from the evaluation module 470, which will be described below, as feedback input, for example for refinement and fine-tuning.

The task prompt enhancing module 460 is configured to generate enhanced baseline task prompts using the variant meta prompts generated by the meta prompt rephrasing module 450. The task prompt enhancing module 460 can implement or use a trained LLM from a model store 420 on the communication platform 310 or from a remote server 380. The trained LLM can be the same as or different from the trained LLM used in the task prompt enhancement engine 430. A variant meta prompt is used as an instruction to the trained LLM (e.g., a prompt to the trained LLM). A baseline task prompt, for example stored in the data store 410, is provided as input data to the trained LLM. The trained LLM can generate an enhanced baseline task prompt as output data based on the variant meta prompt and the baseline task prompt. For a set of baseline task prompts, the task prompt enhancing module 460 can generate a set of enhanced baseline task prompts using one variant meta prompt. With multiple variant meta prompts generated by the meta prompt rephrasing module 450, the task prompt enhancing module can generate multiple sets of enhanced baseline task prompts.

The evaluation module 470 is configured to generate evaluation data associated with the variant meta prompts generated by the meta prompt rephrasing module 450. In some examples, the evaluation module 470 implements or uses a trained LLM to generate enhanced baseline outputs based on a set of baseline inputs stored in the data store 410 as input data and an enhanced baseline task prompt as instructions (which is a prompt to the trained LLM). The enhanced baseline task prompt was generated using a variant meta prompt and a corresponding baseline task prompt by the task prompt enhancing module 460, as described above. The evaluation module 470 can implement or use a trained LLM from a model store 420 on the communication platform 310 or from a remote server 380, for generating enhanced baseline outputs based on the baseline inputs and enhanced baseline task prompts. In some examples, the baseline outputs are stored in the data store 410. The baseline outputs can be pre-generated using the baseline inputs and the set of baseline task prompts, both of which are stored in the data store 410. The trained LLM for generating the enhanced baseline outputs can be the same LLM used to generate the baseline outputs. In some examples, the baseline outputs are not stored in the data store 410. The evaluation module 470 can implement the same trained LLM for generating enhanced baseline outputs to generate baseline outputs based on baseline inputs and baseline task prompts.

The evaluation module 470 can evaluate the enhanced baseline outputs by comparing the enhanced baseline outputs to the baseline outputs. The evaluation module 470 can implement an evaluation algorithm to generate an evaluation report for enhanced baseline outputs, including evaluation scores and corresponding reasoning data. The evaluation scores and corresponding reasoning data may be modified or not modified as evaluation scores and corresponding reasoning data for corresponding variant meta prompts, which was used to generate enhanced baseline task prompts as instructions to generate the enhanced baseline outputs. The evaluation algorithm can be preconfigured with evaluation categories for the enhanced baseline outputs. The evaluation categories can be specified by an operator. Examples of evaluation categories can include whether the type of generated output matches the expected output type (e.g., if the task prompt asks for a summary, is the output a summary?) and the quality of the generated output (e.g., conciseness, relevancy, etc.) Examples of the evaluation algorithm can be autoencoders, predictor models, or other deep neural networks. In some examples, the evaluation algorithm generates embedding vectors, for example at sentence level or word level, for the enhanced baseline outputs and the original baseline output. The embedding vectors can be processed to extract feature embeddings, for example for representing features corresponding to the predefined evaluation categories. The feature embeddings corresponding to the enhanced baseline outputs can be compared with those corresponding to the baseline outputs to determine if there is any improvement in the enhanced baseline outputs according to certain evaluation categories, such as the conciseness of the output.

An evaluation score can be determined for a variant meta prompt which was used as a prompt for a trained LLM to generate enhanced baseline task prompts, which in turn are used as prompts for a trained LLM to generate the enhanced baseline outputs. Meanwhile, reasoning data associated with the evaluation score is also provided by the evaluation algorithm. The reasoning data explains why the variant meta prompt gets the corresponding evaluation score. The evaluation score and the reasoning data are based on the analysis of the feature embeddings with respect to the predetermined evaluation categories. Alternatively, or additionally, the evaluation algorithm can be a trained LLM from a model store 420 on the communication platform 310 or from a remote server 380 configured to generate an evaluation report for a set of enhanced baseline outputs, which were generated based on a set of enhanced baseline task prompts (as instructions to a trained LLM with baseline inputs as input data), which in turn were generated based on a variant meta prompt (as the instruction to the trained LLM in the task prompt enhancing module 460). Thus, the evaluation report for the set of enhanced baseline outputs corresponds to a variant meta prompt. The evaluation report can be modified or not to present the evaluation for the variant meta prompt. There can be multiple evaluation reports for the multiple variant meta prompts.

The evaluation module 470 can rank the variant meta prompts based on corresponding evaluation scores and determine if the highest evaluation score satisfies a predetermined threshold. If the highest evaluation score satisfies the predetermined threshold, for example equal to or greater than a predetermined threshold value, the variant meta prompt with the highest evaluation score can be selected as an optimized meta prompt to be provided to the task prompt enhancement engine 430. If the highest evaluation score does not satisfy the predetermined threshold, for example less than a predetermined threshold value, the meta prompt rephrasing module 450 can continue to generate more and different variant meta prompts based on the initial meta prompt for further enhancing baseline task prompts and generating further enhanced baseline outputs for further evaluation, generally as describe above.

The evaluation module 470 can generate an evaluation summary based on the multiple evaluation reports for the multiple variant meta prompts respectively. In some examples, the evaluation module 470 implements a generative model to generate an evaluation summary based on a set of evaluation reports associated with a set of variant meta prompts. In some examples, the evaluation module 470 implements a clustering model to extract and cluster individual evaluation points across the evaluation reports associated with the multiple variant meta prompts. The evaluation summary includes common evaluation points for the set of variant meta prompts. As mentioned above, the evaluation summary can be provided to the meta prompt rephrasing module 450 as feedback to refine or fine-tune an LLM implemented by the meta prompt rephrasing module 450.

The communication application 480 installed on the client device 340 can include a local data store 485, a local meta prompt optimization engine 490, and a local task prompt enhancement engine 495. The local data store 475 can store historical communication data associated with client device 330, among other types of data. The historical communication data can include video conference recordings, video conference transcripts, chat messages, emails, and other types of communication data. The historical communication data can be used as inputs to LLMs for generating outputs for certain generative tasks. The outputs from the LLMs based on the inputs can also be stored in the data store 410. The local meta prompt optimization engine 490 can be configured to provide an optimized meta prompt as a prompt for the local task prompt enhancement engine 495, similar to the meta prompt optimization engine 440 on the communication platform 310. The local task prompt enhancement engine 495 can be configured to generate an enhanced task prompt based on a task prompt provided by a user associated with the client device 330, similar to the task prompt enhancement engine 430 on the communication platform 310. The local task prompt enhancement engine 495 can implement or use a trained LLM from the model store 420 on the communication platform 310 or from the remote server 380. The local task prompt enhancement engine 495 can use an optimized meta prompt as instructions, which can be provided by the meta prompt optimization engine 440 on the communication platform 310 or by the local meta prompt optimization engine 490.

The communication application 480 can also provide a graphical user interface (GUI) for a virtual communication session and a GUI for task prompt enhancement. In some examples, the GUI for the task prompt enhancement is a GUI element within the GUI for the virtual communication session. In some examples, the GUI for the task prompt enhancement is a separate tab on the GUI of the communication application 480, where a user can enhance their own task prompts before providing it to an LLM-enabled module. In some examples, the task prompt enhancement feature is not visible to a user associated with the client device 330, but is integrated with a generative module (not shown) for certain generative tasks in the communication application 480. When a user provides a task prompt to the LLM-enabled generative engine, for example summary generation engine, the LLM-enabled generative engine can first implement the local task prompt enhancement engine 495 to obtain an enhanced task prompt, and then uses the enhanced task prompt to generate certain outputs based on user provided input data. The generated output is displayed in the GUI to the user. The enhanced task prompt may not be displayed to the user.

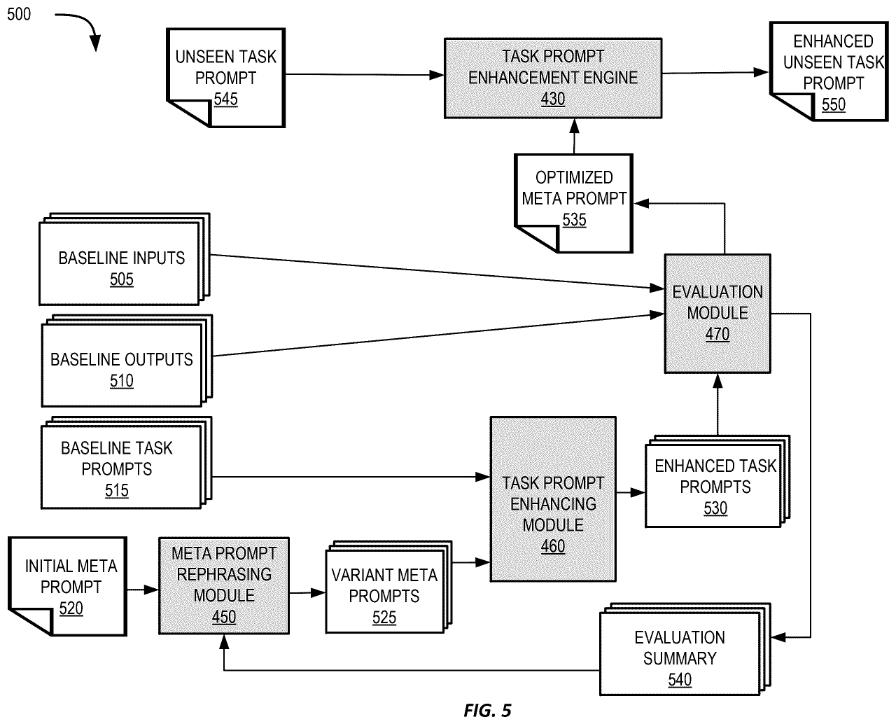

Now referring to FIG. 5, FIG. 5 shows an example diagram 500 of providing an optimized meta prompt for task prompt enhancement. In FIG. 5, an initial meta prompt 520 can be a default meta prompt on a communication platform 310. The initial meta prompt can be written by an operator on the communication platform. The initial meta prompt 520 is provided to the meta prompt rephrasing module 450. The meta prompt rephrasing module 450 implements or uses a trained LLM to generate multiple variant meta prompts 525 based on the initial meta prompt 520 as input and an instruction for rephrasing the input to generate a number of (e.g., a specific number, or a range) variants. The task prompt enhancing module 460 implements or uses a trained LLM to generate multiple enhanced baseline task prompts 530 based on the baseline task prompts 515 as input data and the multiple variant meta prompts 525 as instructions (e.g., prompts to the trained LLM). The enhanced baseline task prompts 530 are provided to the evaluation module 470.

The evaluation module 470 implements or uses a trained LLM to generate enhanced baseline outputs based on the baseline inputs 505 as input data and the enhanced baseline task prompts 530 generated based on a variant meta prompt 525 as instructions (e.g., prompts to the trained LLM). The evaluation module 470 then compares the enhanced baseline outputs and corresponding baseline outputs 510 to generate an evaluation report, which can represent evaluation for the corresponding variant meta prompt. Each variant meta prompt can be evaluated independently. There can be multiple evaluation reports corresponding to the multiple variant meta prompts generated by the meta prompt rephrasing module 450. An evaluation report can include an evaluation score corresponding to a variant meta prompt and reasons for the evaluation score. Reasons for getting corresponding evaluation score can include one or more evaluation points. Examples of the evaluation points can include “the generated variant meta prompts need to include instructions for correcting typos in user provided task prompts” or “the generated variant meta prompts need to specify the goal of a task prompt.” The evaluation scores can be used to rank the multiple variant meta prompts. If the highest evaluation score satisfies a predetermined threshold, the variant meta prompt with the highest evaluation score is selected as the optimized meta prompt 535 to provide to the task prompt enhancement engine 430. Meanwhile, common evaluation points can be extracted from the evaluation points included in the reasons in the evaluation reports for the multiple variant meta prompts and aggregated as evaluation summary 540 to provide to the meta prompt rephrasing module 450 as feedback input for the meta prompt rephrasing module 450 to further improve generation of variant meta prompts 525.

When a user provides an unseen task prompt 545 (for example, unseen to the task prompt enhancing module 460, or different from the baseline task prompts), the task prompt enhancement engine 430 generates an enhanced unseen task prompt 550 based on the unseen task prompt 545 and the optimized meta prompt 535. The enhanced unseen task prompt 550 can be provided as a prompt to a generative model with certain user input to generate output desired by the user.

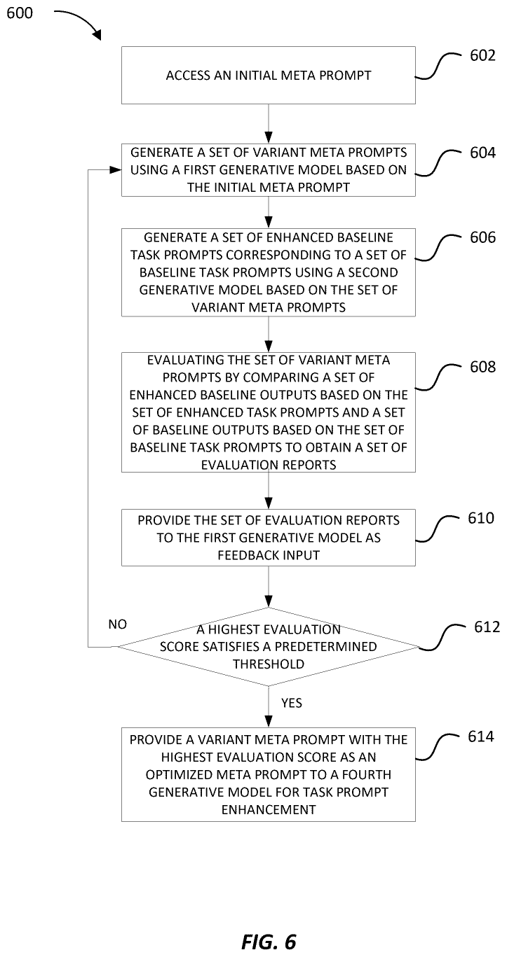

Now referring to FIG. 6, FIG. 6 shows an example process 600 for providing an optimized meta prompt for task prompt enhancement. The example process 600 will be discussed with respect to the system 400 shown in FIG. 4 and the diagram 500 shown in FIG. 5; however, any suitable system for task prompt enhancement may be used.

At block 602, a communication platform 310 accesses an initial meta prompt. A meta prompt is a prompt for a generative model to generate or enhance a task prompt. In other words, a meta prompt can be a prompt of the prompts. A default meta prompt can be provided by the communication platform 310 to a meta prompt optimization engine 440. An operator of the communication platform 310 may or may not update the default meta prompt as the initial meta prompt. Alternatively, a user can provide an initial meta prompt for enhancing a task prompt provided by the user. An example of an initial meta prompt is “As a professional prompt engineer, please enhance user provided task prompts so that an LLM can generate desired results based on the task prompts enhanced by you.”

At block 604, the communication platform 310 generates a set of variant meta prompts using a first generative model based on the initial meta prompt. The meta prompt rephrasing module 450 of the meta prompt optimization engine 440 on the communication platform 310 can implement a trained LLM to generate a set of variant meta prompts using the initial meta prompt as input data and an instruction to rephrase the input data to generate a number of variants (as a prompt to the trained LLM), generally as described in FIG. 4 or FIG. 5. A temperature parameter of the generative model can be adjusted to increase the diversity among generated variants of a provided input. In some examples, the evaluation data for a set of variant meta prompts previously generated can be provided to the meta prompt rephrasing module 450 as feedback input, as will be described at block 610. The meta prompt rephrasing module 450 can fine-tune different parameters of the generative model to improve rephrase or paraphrase generation.

At block 606, the communication platform 310 generates a set of enhanced baseline task prompts corresponding to a set of baseline task prompts using a second generative model based on the set of variant meta prompts. The task prompt enhancing module 460 of the meta prompt optimization engine 440 on the communication platform 310 can generate enhance baseline task prompts corresponding to a set of baseline task prompts, generally as described in FIG. 4 or FIG. 5. The task prompt enhancing module 460 can implement a generative model trained for task prompt enhancement. Using a variant meta prompt as a prompt to the generative model and a baseline task prompt as input, the generative model can generate an enhanced task prompt as output. If there is a set of baseline task prompts, there can be a corresponding subset of enhanced task prompts associated with a variant meta prompt. There can be multiple subsets of enhanced task prompts corresponding to the multiple variant meta prompts in the set of enhanced task prompts.

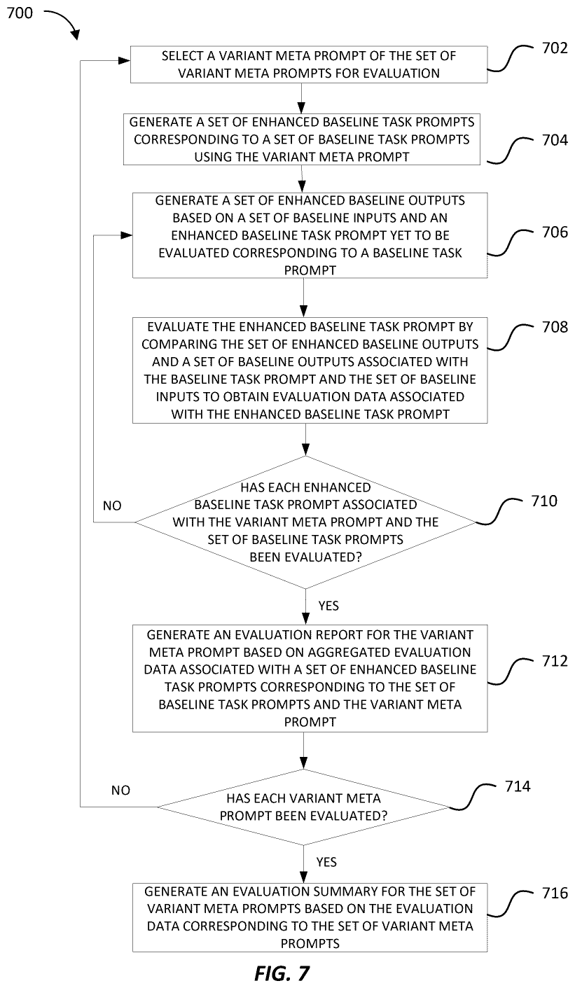

At block 608, the communication platform 310 evaluates the set of variant meta prompts by comparing a set of enhanced baseline outputs corresponding to the set of enhanced baseline task prompts and a set of baseline outputs corresponding to the set of baseline task prompts to obtain a set of evaluation reports. The evaluation module 470 of the meta prompt optimization engine 440 on the communication platform 310 can evaluate the set of variant meta prompts, generally as described in FIG. 4 or FIG. 5. For example, the evaluation module 470 can access a set of baseline inputs and a set of baseline outputs, for example stored in the data store 410. The set of baseline outputs are generated based on the set of baseline inputs and the set of baseline task prompts using a generative model. The evaluation module 470 can implement the same generative model to generate enhanced baseline outputs using the set of baseline inputs as input data and a subset of enhanced baseline prompts associated with a variant meta prompt as instructions (or prompts for the generative model). The evaluation module 470 can evaluate enhanced baseline outputs based on enhanced task prompts associated with the variant meta prompt in view of corresponding baseline outputs to provide an evaluation report for the enhanced baseline outputs associated with the variant meta prompt. The evaluation report for the enhanced baseline outputs associated with the variant meta prompt can be modified or not modified to obtain an evaluation report for the corresponding variant meta prompt. This way, a set of evaluation reports can be obtained corresponding to the set of variant meta prompts. FIG. 7 illustrates an iterative process for evaluating the set of variant meta prompts, which will be described in detail below. The set of evaluation reports for the set of variant meta prompts can include an evaluation score for each variant meta prompt and reasoning data related to why each variant meta prompt is getting the corresponding evaluation score.

At block 610, the communication platform 310 provides the set of evaluation reports to the first generative model as feedback input. The set of evaluation reports can be provided to the meta prompt rephrasing module 450 of the meta prompt optimization engine 440 on the communication platform 310 as feedback input. In some examples, the evaluation module 470 implements an LLM-based summarization model to generate an evaluation summary based on the set of evaluation reports. The evaluation summary is provided to the meta prompt rephrasing module 450 as feedback input. The generative model in the meta prompt rephrasing module 450 can refine or fine-tune itself for generating variant meta prompts using the feedback input. For example, the evaluation summary includes common evaluation points for the set of variant meta prompts, such as “the generated variant meta prompts need to include instructions for correcting typos in user provided task prompts” or “the generated variant meta prompts may specify the goal of a task prompt.” These common evaluation points can be included in the instruction (or prompt) for the generative model when generating variant meta prompts next time. The performance of the meta prompt rephrasing module 450 can be improved in subsequent operations of generating variant meta prompts as described at block 604.

At block 612, the communication platform 310 determines whether a highest evaluation score satisfies a predetermined threshold. The evaluation module 470 can rank the evaluation scores corresponding to the set of variant meta prompts and select the highest evaluation score. The evaluation module 470 can compare the highest evaluation score to a predetermined threshold. If the highest evaluation score does not satisfy the predetermined threshold, for example less than the predetermined threshold, the process returns to block 604 for another iteration. The feedback input provided to the meta prompt rephrasing module 450 at block 610 during last iteration as described above can improve the performance of the meta prompt rephrasing module 450 to generate a different set of variant meta prompts for evaluation following the rest of the steps in example process 600. If the highest evaluation score satisfies the predetermined threshold, for example equal to or higher than the predetermined threshold, the process proceeds to block 614. Block 612 can be optional. In other words, the process 700 for optimizing a meta prompt is not iterative. The process 700 proceeds from block 610 to block 614. In some examples, the communication platform 310 does not compare the highest evaluation score to a predetermined threshold, but directly provides the variant meta prompt with the highest evaluation score as an optimized meta prompt.

At block 614, the communication platform 310 provides a variant meta prompt with the highest evaluation score as an optimized meta prompt to a third generative model for task prompt enhancement. The variant meta prompt with the highest evaluation score which satisfies the predetermined threshold can be considered as an optimized meta prompt for a generative model to enhance a task prompt for a user.

The example process 600 illustrates a method for meta prompt optimization. However, not every step in the example process 600 may be needed, or some steps may be in a different order. The example process 600 is performed by a communication platform 310. Alternatively, the example process 600 can be performed by a communication application 480 installed on a client device 330.

Now referring to FIG. 7, FIG. 7 shows an example process 700 for evaluating variant meta prompts. The example process 700 will be discussed with respect to the system 400 shown in FIG. 4 and the diagram 500 in FIG. 5; however, any suitable system for meta prompt evaluation may be used.

At block 702, a communication platform 310 selects a variant meta prompt of the set of variant meta prompts for evaluation. The meta prompt rephrasing module 450 can generate a set of variant meta prompts based on the initial meta prompts. The performance of each variant meta prompt can be evaluated. The set of variant meta prompts can be evaluated in parallel or in sequence. Either way, the evaluation process for one variant meta prompt can be independent from that for another.

At block 704, the communication platform 310 generates a set of enhanced baseline task prompts corresponding to a set of baseline task prompts using the variant meta prompt. In some examples, the task prompt enhancing module 460 has generated enhanced baseline task prompts using the set of variant meta prompts, for example at block 606 in FIG. 6. The evaluation module 470 can then access a set of enhanced baseline task prompt corresponding to a set of baseline task prompts and the variant meta prompt selected for evaluation at block 702. In other examples, in response to the operation at block 702, the task prompt enhancing module 460 implements or uses a trained LLM to generate a set of enhanced baseline task prompts using a set of baseline task prompts as input and the variant meta prompt selected for evaluation at block 702 as an instruction (a prompt to the trained LLM), generally as described at block 606.

At block 706, the communication platform 310 generates a set of enhanced baseline outputs based on a set of baseline inputs and an enhanced baseline task prompt yet to be evaluated corresponding to a baseline task prompt and the variant meta prompt. The evaluation module 470 can access the set of baseline inputs, for example stored in the data store 410. The evaluation module 470 can implement a generative model to generate a set of enhanced baseline outputs, using the enhanced baseline task prompt yet to be evaluated as an instruction (a prompt to the generative model) and the set of baseline inputs as input data.

At block 708, the communication platform 310 evaluates the enhanced task prompt by comparing the set of enhanced baseline outputs and a set of baseline outputs associated with the baseline task prompt and the set of baseline inputs to obtain evaluation data associated with the enhanced task prompt. In some examples, a set of baseline outputs generated based on the set of baseline inputs using a set of baseline task prompts are also stored in the data store 410 for access. In other examples, the evaluation module 470 can implement the same generative model as at block 706 to generate a set of baseline outputs based on a baseline task prompt corresponding to the enhanced baseline task prompt and the set of baseline inputs. The evaluation module 470 can evaluate the set of enhanced baseline outputs in view of the set of baseline outputs, generally as described in FIG. 4 or FIG. 5. In some examples, the evaluation module 470 generates evaluation data for the enhanced baseline task prompt based on the evaluation of the set of enhanced baseline outputs associated with the enhanced baseline task prompt.

At block 710, the communication platform 310 determines if each enhanced baseline task prompt associated with the variant meta prompt and the set of baseline task prompts has been evaluated. If not every enhanced baseline task prompt associated with the variant meta prompt and the set of baseline task prompts has been evaluated, the example process 700 returns to block 706 to apply an enhanced baseline task prompt yet to be evaluated to a set of baseline inputs to obtain another set of enhanced baseline outputs for evaluation at block 708, until each enhanced baseline task prompts has been evaluated. The process then proceeds to block 712.

At block 712, the communication platform 310 generates an evaluation report for the variant meta prompt based on aggregated evaluation data associated with a set of enhanced baseline task prompts corresponding to the set of baseline task prompts and the variant meta prompt. The evaluation data associated with a set of enhanced baseline task prompts corresponding to the variant meta prompt can be aggregated to generate the evaluation report for the variant meta prompt. The evaluation report for the variant prompt can include an evaluation score for the variant meta prompt and reasoning data about why the variant meta prompt is getting the corresponding evaluation score.

At block 714, the communication platform 310 determines if each variant meta prompt has been evaluated. If not every variant meta prompt has been evaluated, the example process 700 returns to block 702 to select another variant meta prompt of the initial meta prompt for evaluation, following the rest of the steps in example process 700. If each variant meta prompt generated by the meta prompt rephrasing module 450 has been evaluated, the process proceeds to block 716.

At block 716, the communication platform 310 generates an evaluation summary for the set of variant meta prompts based on a set of evaluation reports corresponding to the set of variant meta prompts. In some examples, the evaluation module 470 implements a generative model to generate an evaluation summary based on the evaluation reports associated with the set of variant meta prompts obtained at block 712 at each iteration for a variant meta prompt. In some examples, the evaluation module 470 implements a clustering model to extract and cluster individual evaluation points across evaluation data corresponding to the set of variant meta prompts. The evaluation summary includes common evaluation points for the set of variant meta prompts.

The example process 700 illustrates a method for meta prompt evaluation. However, not every step in the example process 700 may be needed, or some steps may be in a different order. The example process 700 is performed by a communication platform 310. Alternatively, the example process 700 can be performed by a communication application 480 installed on a client device 330.

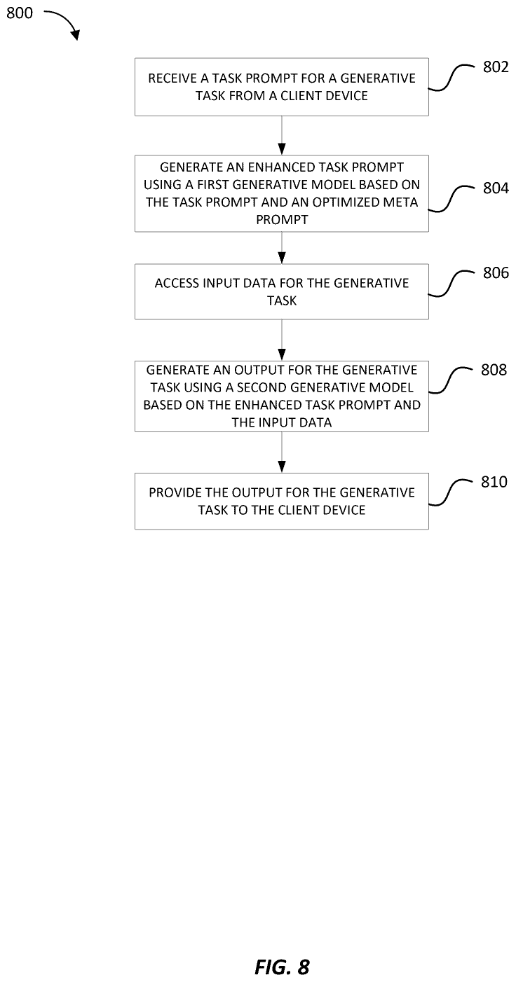

Now referring to FIG. 8, FIG. 8 shows an example process 800 for performing a generative task based on a task prompt. The example process 800 will be discussed with respect to the system 400 shown in FIG. 4 and the diagram 500 in FIG. 5; however, any suitable system for output generation based on a task prompt may be used.

At block 802, a communication platform 310 receives a task prompt for a generative task from a client device 330. A user associated with a client device 330 can enter a task prompt via a GUI of a communication application 480 installed on the client device 330 and provided by the communication platform 310. The task prompt includes instructions to a generative model for a generative task. For example, a task prompt provided by a user is “Based on the provided transcript, please generate a summary.”

At block 804, the communication platform 310 generates an enhanced task prompt using a first generative model based on the task prompt and an optimized meta prompt. The task prompt enhancement engine 430 on the communication platform 310 can enhance the task prompt based on an optimized meta prompt, which can be obtained by optimizing an initial meta prompt via example process 600. For example, the initial meta prompt is” You are a senior prompt engineer. Please optimize existing prompts so that an LLM can better follow it.” An example optimized meta prompt can be “As a senior prompt engineer, your task is to enhance existing task prompts to ensure they provide clear, specific instructions to a large language model. The enhanced task prompt should correctly describe the described output. For example, the type of the output, the tone of the output, and the structure of the output, and the key information that should be included in the output.” The optimized meta prompt functions as an instruction to a generative model implemented by the task prompt enhancement engine 430. The task prompt provided by the user at block 802 is input data for the generative model, and the output is an enhanced task prompt. For example, the enhanced task prompt is “Based on the provided meeting transcript, please generate a summary of the meeting, including the attendants, topics discussed, and action items.”

At block 806, the communication platform 310 accesses input data for the generative task. In some examples, the user associated with the client device 330 provides input data for the generative task along with the task prompt. In some examples, the input data is stored in the data store 410 on the communication platform 310, for example a meeting transcript for a video meeting. The user can provide a link or description of the input data. The communication platform 310 can retrieve the input data from the data store 410 based on the information provided by the user.

At block 808, the communication platform 310 generates an output for the generative task using a second generative model based on the enhanced task prompt and the input data. The communication platform 310 can implement a generative model trained for performing similar generative tasks to generate an output based on the enhanced task prompt and the input data.

At block 810, the communication platform 310 provides the output for the generative task to the client device 330. In some examples, the output for the generative task is visual, for example an image, the output can be displayed on the GUI of the communication application 480 installed on the client device 330 and provided by the communication platform 310. In some examples, the output is in audio format, and the audio output can be played on the client device 330. In some examples, the output is text, and the output can be displayed or played on the client device 330 to the user associated with the client device 330.

The example process 800 illustrates a method for performing a generative task. However, not every step in the example process 800 may be needed, or some steps may be in a different order. The example process 800 is performed by a communication platform 310. Alternatively, the example process 800 can be performed by a communication application 480 installed on a client device 330.

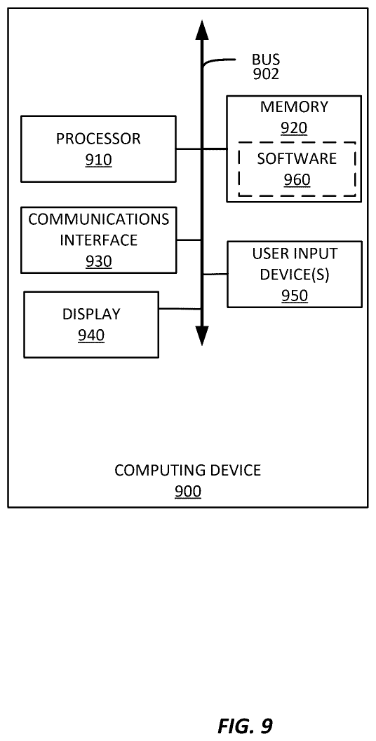

Now referring to FIG. 9, FIG. 9 shows an example computing device 900 suitable for use in example systems or methods for prompt enhancement. The example computing device 900 includes a processor 910 which is in communication with the memory 920 and other components of the computing device 900 using one or more communications buses 902. The processor 910 is configured to execute processor-executable instructions stored in the memory 920 to perform one or more methods for prompt enhancement, such as part or all of the example processes 600, 700, and 800, described above with respect to FIGS. 6, 7, and 8. The computing device, in this example, also includes one or more user input devices 950, such as a keyboard, mouse, touchscreen, video input device (e.g., one or more cameras), microphone, etc., to accept user input. The computing device 900 also includes a display 940 to provide visual output to a user. The computing device 900 may also include software 960. The software 960 may include a communication application (client application), a communication platform, and any other software to enable communication from a first user to a second user.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing an initial meta prompt, wherein the initial meta prompt is a prompt for a generative model to enhance a task prompt;
generating a first set of variant meta prompts using a first generative model based on the initial meta prompt;
generating a first set of enhanced baseline task prompts corresponding to a set of baseline task prompts using a second generative model based on the first set of variant meta prompts;
evaluating the first set of variant meta prompts by comparing a first set of enhanced baseline outputs corresponding to the set of enhanced baseline task prompts and a set of baseline outputs corresponding to the set of baseline task prompts to obtain a first set of evaluation data;
selecting a first variant meta prompt as a first optimized meta prompt based on the first set of evaluation data; and
providing the first optimized meta prompt to a third generative model for task prompt enhancement.

2. The method of claim 1, further comprising:
receiving a task prompt from a user device; and
generating an enhanced task prompt using the third generative model based on the task prompt and the first optimized meta prompt.

3. The method of claim 2, further comprising:
receiving input data for a generative task from a user device;
generating an output using a fifth generative model based on the input data and the enhanced task prompt; and
providing the output for the generative task to the user device.

4. The method of claim 1, wherein evaluating the first set of variant meta prompts by comparing a first set of enhanced baseline outputs corresponding to the set of enhanced baseline task prompts and a set of baseline outputs corresponding to the set of baseline task prompts comprises:
applying an enhanced baseline task prompt and a variant meta prompt of the first set of variant meta prompts to a baseline input to obtain an enhanced baseline output;
evaluating the enhanced baseline task prompt by comparing the enhanced baseline output corresponding to the enhanced baseline task prompt and a baseline output corresponding to a baseline task prompt associated with the enhanced baseline task prompt to obtain evaluation data associated with the enhanced baseline task prompt;
generating a subset of evaluation data for the variant meta prompt based on a subset of evaluation data associated with a subset of the first set of enhanced baseline task prompts corresponding to the set of baseline task prompts enhanced by the variant meta prompt; and
aggregating subsets of evaluation data for the set of variant meta prompts to obtain the first set of evaluation data.

5. The method of claim 1, wherein the first set of evaluation data comprises multiple evaluation scores corresponding to the first set of variant meta prompts, wherein
selecting a variant meta prompt as a first optimized meta prompt based on the first set of evaluation data comprises:
determining whether a highest evaluation score of the multiple evaluation scores satisfies a predetermined threshold; and
in response to determining the highest evaluation score of the multiple evaluation scores satisfies a predetermined threshold, selecting the variant meta prompt corresponding to the highest evaluation score as the first optimized meta prompt.

6. The method of claim 5, further comprising:
in response to determining the highest evaluation score of the multiple evaluation scores does not satisfy the predetermined threshold,
generating a second set of variant meta prompts using the first generative model based on the initial meta prompt;
generating a second set of enhanced baseline task prompts corresponding to the set of baseline task prompts using the second generative model based on the second set of variant meta prompts;
evaluating the second set of variant meta prompts comparing a second set of enhanced baseline outputs corresponding to the second set of enhanced baseline task prompts and the set of baseline outputs corresponding to the set of baseline task prompts to provide a second set of evaluation data;
selecting a second variant meta prompt from the second set of variant meta prompts as a second optimized meta prompt based on the second set of evaluation data; and
providing the second optimized meta prompt to the third generative model for task prompt enhancement.

7. The method of claim 1, wherein the first set of evaluation data comprises analytics data associated with the first set of variant meta prompts, wherein the method further comprises:
extracting a set of common points from the analytics data associated with the first set of variant meta prompts; and
provide the set of common points as feedback input to the first generative model for variant meta prompt generation.

8. The method of claim 1, wherein the set of baseline task prompts comprise prompts for a set of tasks, wherein the set of tasks comprise summarization, paraphrasing, evaluation, question-answer generation, audio generation, or video generation.

9. The method of claim 1, wherein generating a first set of variant meta prompts using a first generative model based on the initial meta prompt comprising:
diversifying the initial meta prompt by setting a temperature parameter of the first generative model above a predetermined value to obtain the first set of variant meta prompts.

10. The method of claim 1, wherein at least the second generative model and the third generative model are the same generative model.

11. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
access an initial meta prompt, wherein the initial meta prompt is a prompt for a generative model to enhance a task prompt;
generate a first set of variant meta prompts using a first generative model based on the initial meta prompt;
generate a first set of enhanced baseline task prompts corresponding to a set of baseline task prompts using a second generative model based on the first set of variant meta prompts;
evaluate the first set of variant meta prompts by comparing a first set of enhanced baseline outputs corresponding to the set of enhanced baseline task prompts and a set of baseline outputs corresponding to the set of baseline task prompts to obtain a first set of evaluation data;
select a first variant meta prompt as a first optimized meta prompt based on the first set of evaluation data; and
provide the first optimized meta prompt to a third generative model for task prompt enhancement.

12. The system of claim 11, wherein the one or more processors are configured to execute further processor-executable instructions stored in the non-transitory computer-readable medium to:
receive a task prompt from a user device;
generate an enhanced task prompt using the third generative model based on the task prompt and the first optimized meta prompt.
access input data for a generative task;
generate an output using a fifth generative model based on the input data and the enhanced task prompt; and
providing the output for the generative task to the user device.

13. The system of claim 11, wherein the one or more processors are configured to execute further processor-executable instructions stored in the non-transitory computer-readable medium to:
apply an enhanced baseline task prompt and a variant meta prompt of the first set of variant meta prompts to a baseline input to obtain an enhanced baseline output;
evaluate the enhanced baseline task prompt by comparing the enhanced baseline output corresponding to the enhanced baseline task prompt and a baseline output corresponding to a baseline task prompt associated with the enhanced baseline task prompt to obtain evaluation data associated with the enhanced baseline task prompt;
generate a subset of evaluation data for the variant meta prompt based on a subset of evaluation data associated with a subset of the first set of enhanced baseline task prompts corresponding to the set of baseline task prompts enhanced by the variant meta prompt; and
aggregate subsets of evaluation data for the set of variant meta prompts to obtain the first set of evaluation data.

14. The system of claim 11, wherein the first set of evaluation data comprises multiple evaluation scores corresponding to the first set of variant meta prompts, wherein the one or more processors are configured to execute further processor-executable instructions stored in the non-transitory computer-readable medium to:
determine whether a highest evaluation score of the multiple evaluation scores satisfies a predetermined threshold; and
in response to determining the highest evaluation score of the multiple evaluation scores satisfies a predetermined threshold, select a variant meta prompt corresponding to the highest evaluation score as the first optimized meta prompt.

15. The system of claim 14, wherein the one or more processors are configured to execute further processor-executable instructions stored in the non-transitory computer-readable medium to:
in response to determining the highest evaluation score of the multiple evaluation scores does not satisfy the predetermined threshold,
generate a second set of variant meta prompts using the first generative model based on the initial meta prompt;
generate a second set of enhanced baseline task prompts corresponding to the set of baseline task prompts using the second generative model based on the second set of variant meta prompts;
evaluate the second set of variant meta prompts comparing a second set of enhanced baseline outputs corresponding to the second set of enhanced baseline task prompts and the set of baseline outputs corresponding to the set of baseline task prompts to provide a second set of evaluation data;
select a second variant meta prompt from the second set of variant meta prompts as a second optimized meta prompt based on the second set of evaluation data; and
provide the second optimized meta prompt to the third generative model for task prompt enhancement.

16. The system of claim 11, wherein the first set of evaluation data comprises analytics data associated with the first set of variant meta prompts, wherein the one or more processors are configured to execute further processor-executable instructions stored in the non-transitory computer-readable medium to:
generate an evaluation summary comprising a set of evaluation points based on the analytics data associated with the first set of variant meta prompts; and
provide the evaluation summary as feedback input to the first generative model for variant meta prompt generation.

17. A non-transitory computer-readable medium comprising processor-executable instructions configured to cause one or more processors to:
access an initial meta prompt, wherein the initial meta prompt is a prompt for a generative model to enhance a task prompt;
generate a first set of variant meta prompts using a first generative model based on the initial meta prompt;
generate a first set of enhanced baseline task prompts corresponding to a set of baseline task prompts using a second generative model based on the first set of variant meta prompts;
evaluate the first set of variant meta prompts by comparing a first set of enhanced baseline outputs corresponding to the set of enhanced baseline task prompts and a set of baseline outputs corresponding to the set of baseline task prompts to obtain a first set of evaluation data;
select a first variant meta prompt as a first optimized meta prompt based on the first set of evaluation data; and
provide the first optimized meta prompt to a third generative model for task prompt enhancement.

18. The non-transitory computer-readable medium of claim 17, further comprising processor-executable instructions configured to cause one or more processors to:
receive a task prompt from a user device;
generate an enhanced task prompt using the third generative model based on the task prompt and the first optimized meta prompt.
access input data for a generative task;
generate an output using a fifth generative model based on the input data and the enhanced task prompt; and
providing the output for the generative task to the user device.

19. The non-transitory computer-readable medium of claim 17, further comprising processor-executable instructions configured to cause one or more processors to:
generate an evaluation summary comprising a set of evaluation points based on the first set of evaluation data associated with the first set of variant meta prompts; and
provide the evaluation summary as feedback input to the first generative model for variant meta prompt generation.

20. The non-transitory computer-readable medium of claim 17, further comprising processor-executable instructions configured to cause one or more processors to:
apply an enhanced baseline task prompt and a variant meta prompt of the first set of variant meta prompts to a baseline input to obtain an enhanced baseline output;
evaluate the enhanced baseline task prompt by comparing the enhanced baseline output corresponding to the enhanced baseline task prompt and a baseline output corresponding to a baseline task prompt associated with the enhanced baseline task prompt to obtain evaluation data associated with the enhanced baseline task prompt;
generate a subset of evaluation data for the variant meta prompt based on a subset of evaluation data associated with a subset of the first set of enhanced baseline task prompts corresponding to the set of baseline task prompts enhanced by the variant meta prompt; and
aggregate subsets of evaluation data for the set of variant meta prompts to obtain the first set of evaluation data.
